(19) United States
(12) Patent Application Publication
(10) Pub. No.: US 2025/0135246 A1
(43) Pub. Date: May 1, 2025

(54) SAFETY HARNESS

(71) Applicant: Palfinger AG, Bergheim bei Salzburg (AT)

(72) Inventor: Christian HORA, Eugendorf (AT)

(21) Appl. No.: 19/006,871

(22) Filed: Dec. 31, 2024

Related U.S. Application Data
(63) Continuation of application No. PCT/AT2023/060232, filed on Jul. 11, 2023.

(30) Foreign Application Priority Data
Jul. 14, 2022 (AT) 50111/2022

(51) Int. Cl. A62B 35/00

(52) U.S. Cl. CPC A62B 35/0018; A62B 35/0037

(57) ABSTRACT

A safety harness for protecting a user against falls, includes a hip strap, leg loops, shoulder straps, and a sternal fall arrest eyelet and/or dorsal fall arrest eyelet. The safety harness has a guide extending at least partially along the hip strap, on or in which guide a retaining plate is displaceably mounted via a bearing device, and the retaining plate has connection means (a connector) for releasably connecting a remote control.

The present application is a continuation of International Application PCT/AT2023/060232 filed on Jul. 11, 2023. Thus, all of the subject matter of International Application PCT/AT2023/060232 is incorporated herein by reference.

### BACKGROUND OF THE INVENTION

The present invention relates to a safety harness for protecting a user against falls.

In the state of the art, safety harnesses are known for protecting a user against falls. Safety harnesses are basically designed to arrest the free fall of a user. A safety harness may consist of straps, hardware components, buckles, and other components, wherein the components are arranged such that the safety harness can support the entire body of a user and keep it in an appropriate position during, and after arresting, a fall. A safety harness can be part of a fall arrest system, which can include an anchor device such as a safety rope.

Safety harnesses are often used in conjunction with a remote control of a lifting device, particularly on construction sites when a lifting device must be operated remotely from a position elevated above the ground.

Due to the high weight of remote controls, which can be in the range of 2 to 3 kilograms, the remote control is usually carried by a user with an additional shoulder strap on the body. This can lead to fatigue, pressure points, and back pain if carried for a long time. In conjunction with a safety harness, the safety harness and the shoulder strap may also interfere with each other, especially when manual handling, such as fastening loads, is necessary. In this case, it may also be necessary to take off the remote control.

### SUMMARY OF THE INVENTION

It is the object of the invention to provide a safety harness which is improved compared to the prior art and in which, in particular, the problems mentioned above do not occur.

A safety harness can basically be understood as a holding device for a user's body, which serves to arrest a user's free fall. A safety harness can be part of personal protective equipment for working at heights.

A safety harness according to the invention comprises at least a hip strap, leg loops, shoulder straps, and at least one sternal fall arrest eyelet and/or at least one dorsal fall arrest eyelet. These parts are arranged such that the safety harness supports the entire body of a user and keeps it in an appropriate position during a fall and after arresting a fall. The hip strap can be looped at least partially around the hip area of a user and can advantageously be made of strap material. The leg loops can be looped at least partially around the legs of a user, particularly in the thigh area, and can advantageously be made of strap material. The shoulder straps can be looped at least partially around the upper part of a user's body, in particular the shoulders, and can advantageously be made of strap material.

A fall arrest eyelet serves as an anchor point for a restraining device such as a safety rope. The harness may have at least one front sternal fall arrest eyelet and/or one rear dorsal fall arrest eyelet. A fall arrest eyelet can be designed as a single anchor point or divided into two points. If a fall arrest loop is divided into two points, the two points can be combined when fastening.

A sternal arrest eyelet can be connected to the hip strap and/or the shoulder straps. A dorsal fall arrest eyelet can be connected to the hip strap and/or the shoulder straps. The hip strap can be connected to the leg loops via at least one connecting bar. The hip strap can be connected to the shoulder straps via at least one connecting bar. The safety harness may have a padding, particularly in the hip strap and back areas.

A safety harness according to the invention is characterized in that the safety harness has a guide which extends at least partially along the hip strap, on or in which guide a retaining plate is displaceably mounted via a bearing device. The retaining plate has connection means (a connector) for releasably connecting a remote control.

In other words, a remote control can be displaceably mounted on a hip strap of a safety harness according to the invention. This is made possible by the retaining plate which is displaceably mounted on the hip strap and the connection means (a connector) for releasably connecting a remote control.

By storing a remote control on the hip strap, an optimized distribution of the weight of the remote control can be achieved. By connecting the hip strap to the shoulder straps, a particularly advantageous distribution of the weight of the remote control can be achieved.

Since the safety harness has a guide that extends at least partially along the hip strap, on or in which a retaining plate for a remote control is displaceably mounted via a bearing device, a remote control arranged on the safety harness in this way can be moved along the hip strap, allowing a user more freedom of movement without having to take off the remote control, for example.

The bearing device can advantageously enable a linear guided movement of the retaining plate relative to the guide. In particular, the guide can be designed to be substantially continuous along its extension on the hip strap, which can result in substantially uninterrupted displaceability along the hip strap.

Advantageously, the bearing device can have at least one bearing point between the retaining plate and the guide and the bearing point is designed as at least one plain bearing and/or as at least one rolling bearing. Such a design of the bearing device can also enable a displacing movement for remote controls with large mass.

The at least one bearing point can be formed at least partially on the retaining plate, in particular on fastening means of the retaining plate, and at least partially on the guide, in particular on or in a section of a casing.

The bearing device can advantageously have a releasable locking device for releasably locking at least one displacement position of the retaining plate relative to the guide. This allows the retaining plate and a remote control to be locked in at least one position along the hip strap. A locking mechanism can be achieved by a form-fitting connection and/or a frictional connection between the retaining plate and the guide.

The guide may extend at least between a sternal position on the hip strap and a position remote from the sternal position. A sternal position can substantially correspond to a position directly in front of a user's body. A remote control arranged on the retaining plate can be conveniently operated by a user. A position away from the sternal position may correspond to a position substantially away from a position directly in front of a user's body. In particular, this may correspond to a laterally remote position. A remote control mounted on the retaining plate can be arranged on the side of a user's body, such as to create more freedom of movement.

The retaining plate can be displaceable at least between the sternal position on the hip strap and the position moved away from the sternal position. This allows a remote control arranged on the retaining plate to be displaced substantially continuously between the sternal position on the hip strap and the position remote from the sternal position.

In one embodiment, the guide can extend substantially along a quarter of the longitudinal extent of the hip strap. The retaining plate and a remote control arranged thereon can be displaceable between a position in front of a user's body and a position to the side of a user's body, for example.

In another embodiment, the guide can extend substantially along half of the longitudinal extent of the hip strap. The retaining plate and a remote control arranged thereon can be displaceable between a position in front of a user's body and a position behind a user's body, for example.

In another embodiment, the guide can extend substantially entirely along half of the longitudinal extent of the hip strap. The retaining plate and a remote control arranged thereon can be displaceable to any position around a user's body.

In an advantageous embodiment, the hip strap can have a circumferential retaining strap which is at least partially covered or enclosed by a casing, wherein the guide is formed at least in sections on or in the casing. The retaining strap can be provided to support a user's body and can be designed as a load-bearing element of the hip strap during or after a fall. The casing can be designed separately from the retaining strap, wherein the guide for supporting the retaining plate can be designed at least in sections on or in the casing.

The guide can be designed at least in sections on or in free ends of the casing running along the retaining strap. The casing can be made of plastic, for example. The retaining plate can be mounted so that it can move along the casing. This can, for example, prevent a displacing movement of the retaining plate from contributing to wear of the retaining strap. The guide can be formed by an opening in the casing into which fastening means of the retaining plate engage, whereby the retaining plate can be displaceably mounted in the casing. The casing can be connected to the retaining strap at least in sections. In particular, the casing can be sewn to the retaining strap.

The retaining plate can have fastening means which engage behind the guide at least in sections. This allows a form fit at least in sections between the retaining plate and the guide to be formed. The retaining plate can advantageously be connected to a remote control in a form-fitting manner using the connection means. For this purpose, the remote control can, for example, have openings in a housing or be provided with an adapter plate having corresponding openings.

Protection is also sought for an arrangement comprising a safety harness as described above and a remote control which can be arranged on the retaining plate of the safety harness, in particular a remote control of a lifting device. The remote control can have at least one opening in a housing for attachment to the safety harness, which can be engaged on its rear by hook-shaped connection means.

In one embodiment of the arrangement, an adapter plate can be provided for fastening the remote control, and the adapter plate can have openings and the connection means can be designed in the shape of a hook to engage behind the openings of the adapter plate.

### BRIEF DESCRIPTION OF THE DRAWINGS

Exemplary embodiments of the invention are discussed with reference to the drawings, in which:

FIG. 1 is a view of an embodiment of a safety harness,

FIG. 2 is a plan view of a hip strap,

FIG. 3 is a detailed view of a remote control, a retaining plate, and a guide of a safety harness,

FIGS. 4a to 4d are detailed views of different embodiments of a hip strap in a front view and a sectional view, and

FIG. 5 is a view of an embodiment of a safety harness with illustrated adjustment ranges.

### DETAILED DESCRIPTION OF THE INVENTION

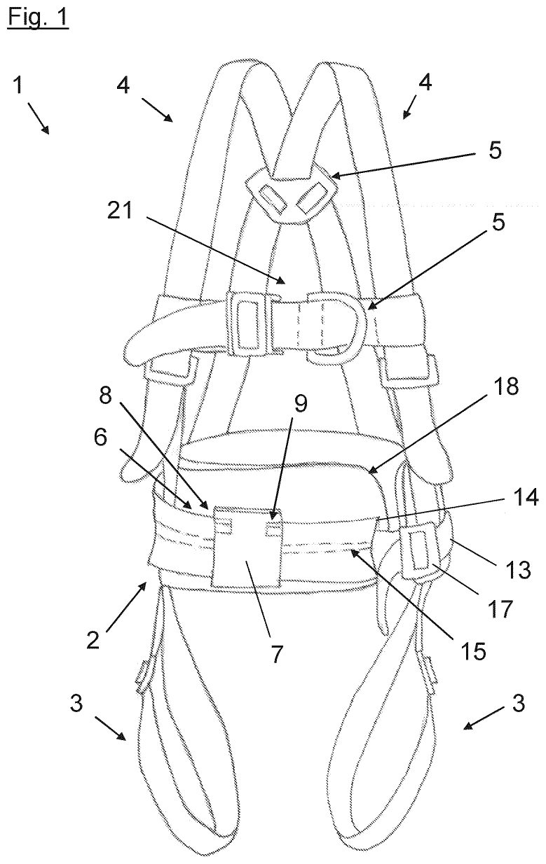

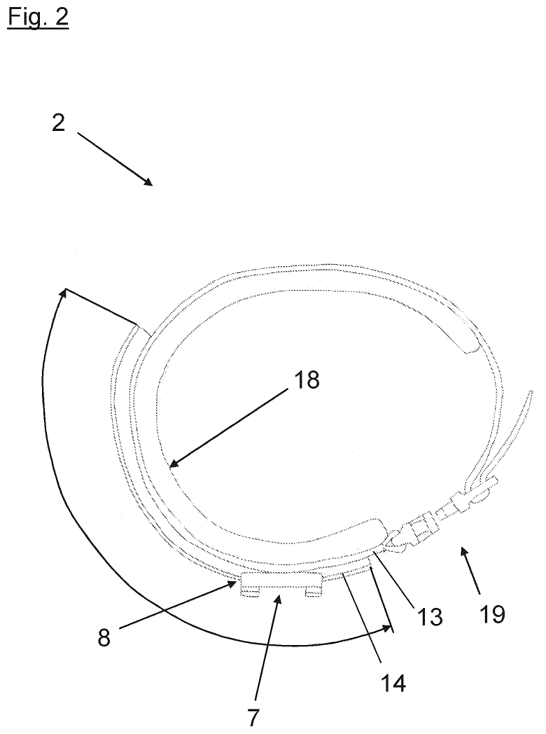

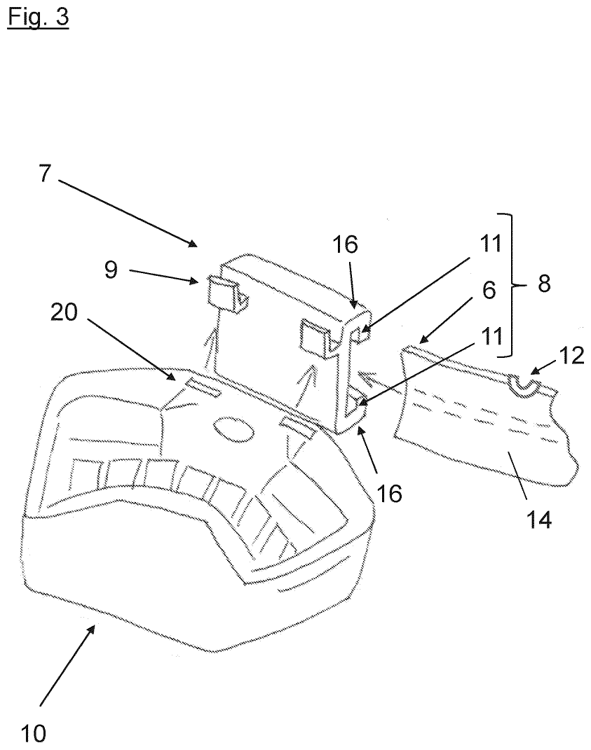

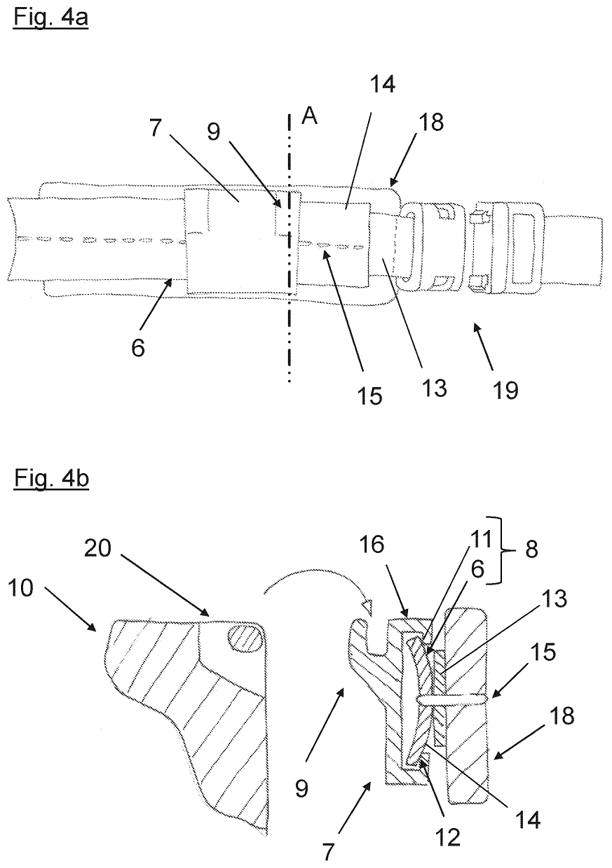

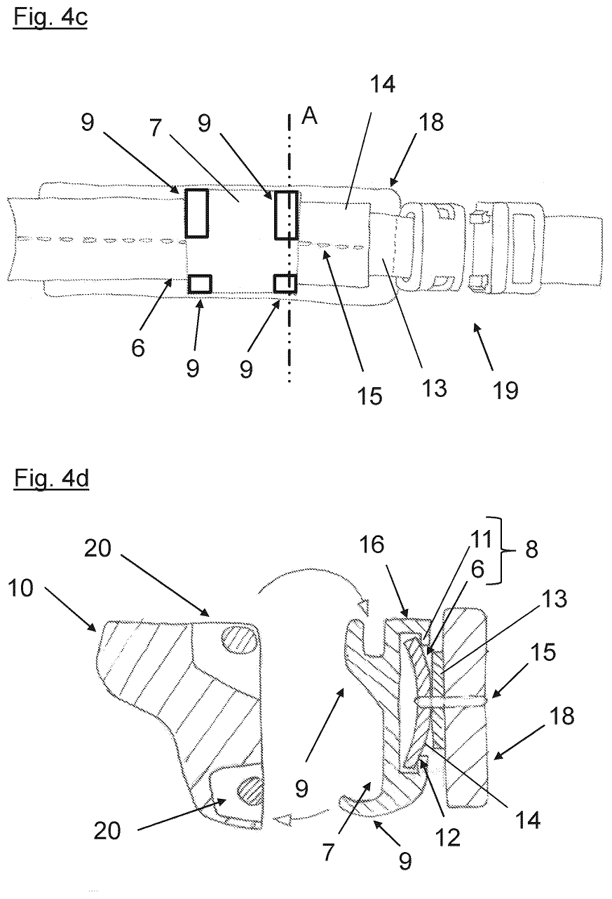

FIG. 1 shows an embodiment of a safety harness 1 for protecting a user against falls, comprising a hip strap 2, leg loops 3, shoulder straps 4, a connecting belt 21 connecting the shoulder straps 4, a sternal fall arrest eyelet 5 and a dorsal fall arrest eyelet 5 (concealed by the shoulder straps 4). In the embodiment shown, the hip strap 2 has a circumferential retaining belt 13 (see also FIG. 2), which is partially covered or enclosed by a casing 14. The safety harness 1 has a guide 6 formed at least in sections on the casing 14 and extending along the hip strap 2 for the displaceable mounting of a retaining plate 7 via a bearing device 8, for which further details can be found in FIGS. 3 and 4b.

A retaining plate 7 is displaceably mounted on the guide 6 at the hip strap 2. The retaining plate 7 has connection means (connector) 9 for releasably connecting a remote control 10 (see, for example, FIGS. 3, 4b, and 5). In the embodiment shown, the connection means 9 are designed in a hook shape to engage behind an opening 20 in the remote control 10. Alternatively, openings in an adapter plate can be used for engaging. The retaining plate 7 is mounted on the hip strap 2 of the safety harness 1 via a bearing device 8, which is shown in more detail in FIGS. 3 and 4b. In particular, the retaining plate 7 can thereby be mounted so as to be displaceable along the casing 14.

As also shown in FIGS. 2 and 4a and 4b, the casing 14 is at least partially connected to the retaining strap 13 and can be sewn thereto, in particular by a seam 15.

In the embodiment of FIG. 1, the circumferential retaining strap 13 of the hip strap 2 is connected to a buckle 17 on one end and can be threaded into the buckle 17 on the other end. The hip strap 2 can be adjusted in length by means of the buckle 17 to be adaptable to different waist sizes of users.

In the embodiment shown, the hip strap 2 of the safety harness 1 has a padding 18, by means of which an advantageous pressure distribution of loads acting on the safety harness 1 can be achieved.

Embodiments of the bearing device 8 for supporting the retaining plate 7 on the guide 6 are shown in more detail in FIGS. 3 and 4b.

In the plan view of an embodiment of a hip strap 2 of a safety harness 1 in FIG. 2, it can be seen that the guide 6, formed by the casing 14 partially covering the retaining strap 13, extends at least between a sternal position on the hip strap 2 and a position remote from the sternal position, and the retaining plate 7 is displaceable along the casing 14 at least between the sternal position on the hip strap 2 and the position remote from the sternal position. The displacement range of the retaining plate 7 can extend, as shown, from a position in front of a user's body to at least one position on the side of a user's body.

The circumferential retaining strap 13 of the hip strap 2 can be connected on one end to a fixed part of a clasp 19 and on the other end of the retaining strap 13 to an adjustment part of the clasp 19. The hip strap 2 can be changed in its length in the adjustment part of the clasp 19 to be adaptable to different waist sizes of users. If the fixed part of the clasp 19 and the adjustment part of the clasp 19 are connected, the hip strap 2 can be closed.

FIG. 3 shows a detailed view of an arrangement consisting of a safety harness 1 and a remote control 10 that can be arranged on the retaining plate 7 of the safety harness 1.

FIG. 3 shows an embodiment of a bearing device 8 for supporting the retaining plate 7 on the guide 6 in detail. In the embodiment shown, the bearing device 8 has bearing points 11 between the retaining plate 7 and the guide 6, wherein the bearing points 11 shown are designed as a plain bearing. It is also conceivable that the bearings could be designed as rolling bearings.

In the embodiment of FIG. 3, the retaining plate 7 has fastening means 16 in the form of hook-shaped projections, which can engage at least in sections behind the guide 6. In the embodiment shown, the bearing points 11 are partially formed on the fastening means 16 and can interact with corresponding areas of the guide 6 (see, for example, FIG. 4b).

Furthermore, the embodiment of the bearing device 8 shown in FIG. 3 has a releasable locking device 12 for releasably locking at least one displacement position of the retaining plate 7 relative to the guide 6. In this embodiment, the locking device 12 can be designed at least in the form of a recess in the guide 6 which forms a form-fitting connection and into which a corresponding projection of the retaining plate 7 can releasably engage. It is not to be excluded that multiple recesses are arranged along the guide 6. An alternative—or combined—embodiment of a locking device 12 can be provided by frictional engagement, as shown in FIG. 4b.

The retaining plate 7 can be connected to a remote control 10 in a form-fitting manner using the connection means 9, for example by engaging in corresponding openings 20 in a housing of the remote control 10. Alternatively, a form-fitting connection can be made with an adapter plate 22 for a remote control 10. FIG. 4a shows a front view of an embodiment of a hip strap 2 according to FIG. 2. FIG. 4b shows a sectional view of a detailed view of an arrangement of a safety harness 1 and a remote control 10 that can be arranged on the retaining plate 7 of the safety harness 1. FIG. 4b shows in detail a sectional view running through the retaining plate 7 along the section line A of FIG. 4a together with a partially shown sectional view through a remote control 10.

The hip strap 2 has a circumferential retaining strap 13, which is partially covered by a casing 14. For optimized pressure distribution, the hip strap 2 has an internal padding 18. The guide 6 for the displaceable mounting of the retaining plate 7 is formed on the casing 14. The casing 14 can be connected to the retaining strap 13 at least in sections and in particular, as shown, sewn to the retaining strap 13 by a seam 15.

The retaining plate 7 is displaceably mounted along the casing 14 which forms the guide 6, via a bearing device 8. In the embodiment shown, the guide 6 can be formed by sections of a flexible casing 14, which, as shown in FIG. 4b, is partially engaged from behind by fastening means 16 of the retaining plate 7.

The bearing device 8 has bearing points 11 designed as plain bearings between the retaining plate 7, in particular between fastening means 16 of the retaining plate 7, and the guide 6.

In the embodiment of FIG. 4b, the bearing device 8 has a locking device 12 in the form of a frictional connection between the fastening means 16 of the retaining plate 7 and the section of the casing 14 forming the guide 6.

The retaining plate 7 can be form-fittingly connected to a remote control 10 in that the connection means 9 engage in corresponding openings 20 in a housing of the remote control 10. Alternatively, a form-fitting connection can be made with an adapter plate 22 for a remote control 10.

In deviation from what is shown, the guide 6 can be formed by an opening in the casing 14 into which fastening means 16 of the retaining plate 7 engage, whereby the retaining plate 7 can be displaceably mounted in the casing 14.

FIG. 4c shows a front view of a further embodiment of a hip strap 2 according to FIG. 2, wherein the retaining plate 7 in the illustration shown has four vertically and horizontally spaced connection means 9. FIG. 4d shows a sectional view of a detailed view of an arrangement of a safety harness 1 and a remote control 10 that can be arranged on the retaining plate 7 of the safety harness 1, wherein specifically a sectional view running through the retaining plate 7 is shown along the section line A of FIG. 4c together with a partially shown sectional view through a remote control 10.

The retaining plate 7 can be form-fittingly connected to a remote control 10 in that the connection means 9 engage in corresponding spaced-apart openings 20 in a housing of the remote control 10. The remote control 10 can initially be connected to the connection means 9 arranged on the upper edge of the retaining plate 7. Subsequently, the remote control 10 can be connected to the connection means 9 arranged on the lower edge of the retaining plate 7, for example by a pivoting movement. Alternatively, a form-fitting connection can be made with a respectively designed adapter plate 22 for a remote control 10.

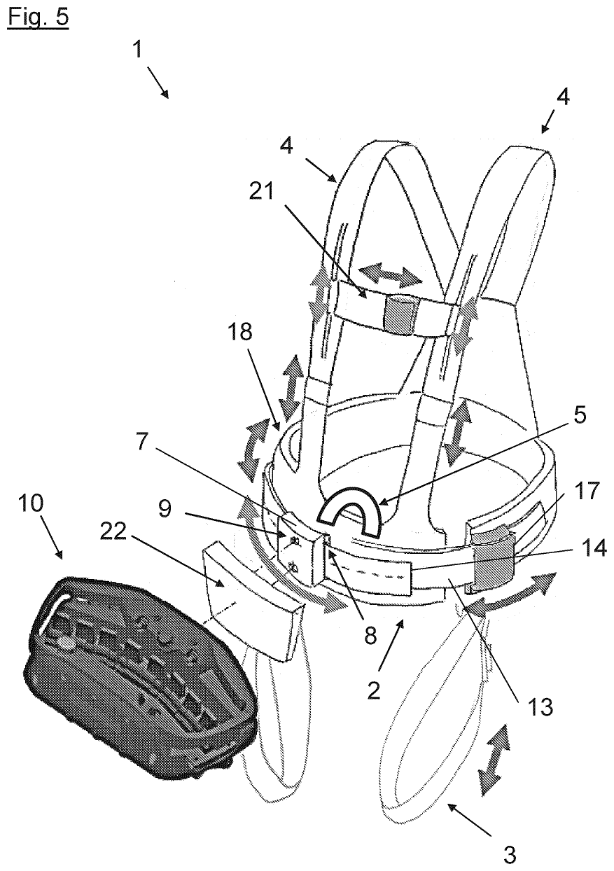

FIG. 5 shows an arrangement consisting of a safety harness 1 and a remote control 10 that can be arranged on the retaining plate 7 of the safety harness 1.

FIG. 5 shows a detailed view of an embodiment of a safety harness 1 with illustrated adjustment ranges of the leg loops 3, the shoulder straps 4, the connecting strap 21, the hip strap 2, and the retaining plate 7 along the hip strap 2. The design of the safety harness 1 largely corresponds to that of the embodiment of FIG. 1, wherein, in the embodiment of FIG. 5, a fall arrest eyelet 5 is arranged on the hip strap 2 and the remote control 10 can be connected to an adapter plate 22, which can be form-fittingly connected to the retaining plate 7 to connect the remote control 10 to the safety harness 1.

### LIST OF REFERENCE NUMERALS

1 safety harness
2 hip strap
3 leg loop
4 shoulder strap
5 fall arrest loop
6 guide
7 retaining plate
8 bearing device
9 connection means
10 remote control
11 bearing point
12 locking device
13 retaining strap
14 casing
15 seam
16 fastening means
17 buckle
18 padding
19 clasp
20 opening
21 connecting strap
22 adapter plate
A section line

1. A safety harness for protecting a user against falls, comprising:
a hip strap;
leg loops;
shoulder straps; and
a sternal fall arrest eyelet and/or dorsal fall arrest eyelet,
wherein the safety harness has a guide extending at least partially along the hip strap, a retaining plate being displaceably mounted on or in the guide via a bearing device, and
wherein the retaining plate has a connection means for releasably connecting a remote control.

2. The safety harness according to claim 1, wherein the bearing device has at least one bearing point between the retaining plate and the guide and the bearing point is designed as at least one plain bearing and/or as at least one rolling bearing.

3. The safety harness according to claim 1, wherein the bearing device has a releasable locking device for releasably locking at least one displacement position of the retaining plate relative to the guide.

4. The safety harness according to claim 1, wherein the guide extends at least between a sternal position on the hip strap and a position remote from the sternal position.

5. The safety harness according to claim 4, wherein the retaining plate is displaceable at least between the sternal position on the hip strap and the position moved away from the sternal position.

6. The safety harness according to claim 1, wherein the hip strap has a circumferential retaining belt which is at least partially covered or enclosed by a casing, wherein the guide is formed at least in sections on or in the casing, wherein preferably the at least one bearing point is formed at least partially on or in the casing.

7. The safety harness according to claim 6, wherein the retaining plate is mounted displaceably along the casing.

8. The safety harness according to claim 6, wherein the casing is at least partially connected to the holding belt, in particular sewn thereto by a seam.

9. The safety harness according to claim 1, wherein the retaining plate has fastening means which engage behind the guide at least in sections, wherein preferably the at least one bearing point is formed at least partially on the fastening means.

10. The safety harness according to claim 1, wherein the retaining plate can be connected in a form-fitting manner to a remote control by means of the connection means.

11. An arrangement comprising a safety harness according to claim 1 and a remote control which can be arranged on the retaining plate of the safety harness.

12. The arrangement according to claim 11, wherein the remote control has at least one opening in a housing and the connection means are designed in a hook shape for engaging behind the at least one opening.

13. The arrangement according to claim 11, wherein the arrangement for the remote control has an adapter plate with openings and the connection means are designed in a hook shape for engaging behind the openings of the adapter plate.
